(19) United States
(12) Patent Application Publication
(10) Pub. No.: US 2010/0079976 A1
(43) Pub. Date: Apr. 1, 2010

(54) LIGHT SOURCE UNIT AND DISPLAY DEVICE

(75) Inventor: Kentaro Kamada, Kameyama-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/442,114

(22) PCT Filed: Sep. 5, 2007
(86) PCT No.: PCT/JP2007/067312

§ 371 Date: Mar. 20, 2009

(30) Foreign Application Priority Data
Dec. 4, 2006 (JP) 2006-327266

(51) Int. Cl. G02F 1/13357; F21V 3/00; F21V 7/00

(52) U.S. Cl. 362/97.1; 362/311.01; 362/296.01; 362/311.03; 362/308

(57) ABSTRACT

A light source unit that prevents deterioration of display qualities, caused by “sagging” of a diffuser, includes a light source, a diffuser, and a light source chassis, the diffuser having a main surface facing the light source, the diffuser being arranged within the light source chassis. The light source unit includes a mounting base at least below a corner of the diffuser, the mounting base includes a diffuser-mounted portion and a projection portion, the projection portion being arranged along an outer edge of the diffuser, the projection portion has a light-shielding property, and the projection portion is arranged to be above a level of an upper surface of the diffuser.

### BACKGROUND OF THE INVENTION

1. Field of the Invention

The present invention relates to a light source unit and a display device. More particularly, the present invention relates to a light source unit that is suitable for use as a direct type backlight in a liquid crystal display device, and to a display device.

2. Description of the Related Art

The light source unit is used, for example, in a display device including a non-self-emission display panel. In a liquid crystal display device, for example, a liquid crystal panel itself does not emit light. Therefore, a transmissive or semi-transmissive liquid crystal display device is provided with a backlight which causes light to enter a liquid crystal panel.

There are currently two different backlights used in a liquid crystal display device and the like: an edge light type (side light type) and a direct type. The direct type backlight has advantages in that it is suitably used in a large-sized display device and easily provides a high luminance. The liquid crystal display device currently has become dramatically larger because a process of using a larger mother glass has been completed, for example. Now the liquid crystal display device has established a position as a household television. In a television, brightness is an important basic performance characteristic. Therefore, a liquid crystal display device equipped with a large screen needs to include a large backlight which provides a high luminance, and therefore, such a liquid crystal display device has been increasingly provided with a direct type backlight.

According to structural characteristics of the direct type backlight, a plurality of light sources such as a cold cathode fluorescent lamp are provided on a back surface of a display panel such as a liquid crystal panel, and as a result, the direct type backlight has the following advantages. Many light sources can be arranged, thereby increasing a light amount; loss of light is small because light is caused to enter the display panel from the light sources without changes in optical path; and the size of the display device can be easily increased. Further, in the direct type backlight, a diffuser or an optical sheet is generally arranged between the display panel and the light source in order to make uniform optical characteristics such as in-plane luminance.

The diffuser tends to sag or deform due to influences such as a difference in temperature between the light source side and the display panel side, the difference in temperature being generated by heat from the light source. Particularly in a large-sized display panel, the diffuser is also large, and therefore, the “sagging” of the diffuser is markedly caused. If the diffuser sags, light, which originally passes through an edge of the diffuser and enters the display panel, enters the display panel without passing through the diffuser. Therefore, uniformity of optical characteristics such as in-plane luminance is deteriorated.

For this problem, Japanese Kokai Publication No. 2004-186080 and Japanese Kokai Publication No. 2004-327449 disclose that a supporting member which projects from the bottom surface side of a backlight is arranged in order to prevent the “sagging” and the like of a diffuser. Japanese Kokai Publication No. 2004-192912 discloses that a diffuser and a frame are integrally arranged. However, for example, in a liquid crystal display device for TV, which is getting larger, the deterioration of display qualities, caused by the “sagging” of the diffuser, particularly strongly need to be prevented. In order to prevent the deterioration of display qualities more easily and effectively, the inventions described in the above prior art references still have room for improvement.

### SUMMARY OF THE INVENTION

In view of the above-mentioned state of the art, preferred embodiments of the present invention provide a light source unit and a display device, each capable of preventing deterioration of display qualities, caused by the “sagging” of the diffuser.

The present inventor made various investigations on a liquid crystal display device for TVs, which is getting larger. The inventor noted that particularly at a corner of a display region, display qualities are markedly deteriorated. As such deterioration of display qualities, a phenomenon in which a white portion is observed at four corners of the display region at the time of a black state is mentioned. Then, the inventor discovered the following. Particularly in the case that a large-sized display panel is used, the “sagging” of the diffuser is markedly generated at corners of the display region, which causes light leakage at the corners of the diffuser. Therefore, the display qualities are deteriorated. Further, the inventor found that this deterioration of display qualities, due to the “sagging” of the diffuser, can be effectively prevented if a projection portion is arranged along the outer edge of the diffuser and arranged to be above the level of the upper surface of the diffuser, using a mounting base for the diffuser, and thereby light leaked from corners of the diffuser can be shielded. As a result, the above-mentioned problems have been admirably solved, leading to development and completion of preferred embodiments of the present invention.

According to a preferred embodiment of the present invention, a light source unit includes a light source, a diffuser, and a light source chassis, the diffuser having a main surface facing the light source, the diffuser being arranged within the light source chassis, wherein the light source unit includes a mounting base at least below a corner of the diffuser, the mounting base includes a diffuser-mounted portion and a projection portion, the projection portion being arranged along an outer edge of the diffuser, the projection portion has a light-shielding property, and the projection portion is located above a level of an upper surface of the diffuser.

According to the light source unit of a preferred embodiment of the present invention, a diffuser which has a main surface facing light sources is arranged within a light source chassis. The light sources are not especially limited, and examples thereof include a dot light source and a linear light source. A light-emitting diode (LED) is mentioned as the dot light source, for example. A cold cathode fluorescent lamp and a hot cathode fluorescent lamp are mentioned as the linear light source, for example. Further, the shape, material, size, and the like of the diffuser are not especially limited as long as it has a function of diffusing light incident from the light sources. The light source chassis is not especially limited as long as it is a case within which the light sources are placed.

The above-mentioned light source unit includes a mounting base at least below a corner of the diffuser. The mounting base is a structure on which the diffuser is mounted. The mounting base is generally arranged along an inner wall surface of the light source chassis constituting an exterior frame of the light source unit so as not to interrupt light from the light sources. If such a mounting base is arranged separately from the light source chassis, the light source unit can be provided with various functions more efficiently in comparison to the case that the light source chassis is processed. As a result, a lamp assembly efficiency is improved.

The above-mentioned mounting base preferably includes a diffuser-mounted portion and a projection portion arranged along the outer edge of the diffuser. The diffuser-mounted portion preferably includes a portion positioned below the diffuser. The shape, size, and the like of the diffuser-mounted portion are not especially limited as long as the diffuser can be mounted on the diffuser-mounted portion. It is preferable that the diffuser-mounted portion has a flat surface on which the diffuser is mounted. If this flat surface on which the diffuser is mounted is further provided with fine irregularities, noise generated when the diffuser contacts the mounting base, for example, by vibration, can be prevented. The projection portion preferably includes a portion which projects to be higher than the diffuser, and is preferably arranged above a level of the upper surface of the diffuser, that is, the height of the projection portion preferably is greater than the thickness of the diffuser. Such a projection portion has a function of shielding light which leaks due to the “sagging” of the diffuser. The “sagging” of the diffuser is most markedly observed at corners of the diffuser. Therefore, the mounting base needs to be arranged at least below the corners of the diffuser. As a structure for light-shielding the diffuser, the projection portion is provided for the mounting base adjacent to the diffuser, and thereby the diffuser can be easily and effectively light-shielded.

FIG. 7 is a perspective view of a commonly used light source unit. FIG. 8 is a cross-sectional schematic view of the light source unit taken along dashed line X-Y in FIG. 7. As shown in FIG. 8, the light source unit generally has a structure in which light sources 1, a diffuser 7, and a display panel 14 are stacked in this order from the bottom, within a frame 12. If such a light source unit is used for a certain period, “sagging” of the diffuser 7 is generated by heat from the light sources 1, as shown in FIG. 8. This “sagging” causes light leakage at corners of the diffuser 7, resulting in deterioration of display qualities. The projection portion of the mounting base included in the light source unit of a preferred embodiment of the present invention is arranged to shield the light leakage generated by the “sagging” of the diffuser. The projection portion is preferably arranged at least along the outer edge of corners of the diffuser 7 where the “sagging” of the diffuser 7 is most markedly observed. For example, if the diffuser 7 has a rectangular main surface, as shown in FIG. 7, the projection portion of the mounting base is arranged at four corners 13a, 13b, 13c, and 13d. According to the light source unit of a preferred embodiment of the present invention, the projection portion of the mounting base is arranged along the outer edge of the corners of the diffuser 7. Therefore, even if the diffuser 7 sags, the leaked light at corners of the display region can be shielded. As a result, the deterioration of display qualities can be prevented.

The above-mentioned projection portion preferably has a light-shielding property, and the projection portion is formed to be above a level of an upper surface of the diffuser. According to such a preferred embodiment, even if the diffuser sags, the leaked light at corners of the display region can be shielded, which can prevent the deterioration of display qualities. Such a projection portion also serves as a guide which regulates a position of the diffuser. The following methods may be mentioned as a method of providing the projection portion with light-shielding property, for example: a method of using a light-shielding material for the projection portion: and a method of subjecting a surface of the projection portion to a light-shielding treatment, and a method of attaching a light-shielding member to the surface of the projection portion. The light-shielding property used herein means that a light-shielding ratio for light (visible light) having a wavelength of about 380 nm to about 780 nm is about 80% or more, for example. As the method of subjecting the projection portion surface to a light-shielding treatment, for example, coating of a light-shielding coating material, formation of a metal thin film by deposition and the like, may be mentioned. As the method of attaching a light-shielding member to the projection portion surface, attachment of a light-shielding tape, attachment of a light-shielding sheet with a cohesive member, and the like, may be mentioned. It is more preferable that the entire mounting base surface is provided with such a light-shielding property.

It is preferable that the height of the projection portion is determined in accordance with a warpage amount of the diffuser. The warpage amount used herein means an amount of a change in shape in the thickness direction between the diffuser before the change and that after the change. Accordingly, it is preferable that the projection portion is arranged to be above the level of the upper surface of a corner of the diffuser which has warped by generated heat in the case that the light source unit is used in a liquid crystal display device. As a rough standard of the warpage amount of the diffuser in the case that the diffuser is used in a common liquid crystal display device, a warpage amount which the diffuser shows when being used in the liquid crystal display device for 1 hour is mentioned. The diffuser no more extremely warps, generally, even if it is used for one or more hours. Therefore, it is preferable that the projection portion is arranged to be above the level of the upper surface of the corner of the diffuser which has warped by being used in a liquid crystal display device for at least one hour, for example.

The configuration of the light source unit of a preferred embodiment of the present invention is not especially limited as long as the above-mentioned light sources, diffuser, and mounting base are included. The light source unit may or may not include other components.

The diffuser sags more on the short sides than on the long sides. Therefore, the projection portion is preferably arranged on the short sides of the diffuser. It is more preferable that the projection portion is arranged on both of the short and long sides. That is, it is preferable that the mounting base is circularly arranged below the outer edge of the diffuser. According to such a preferred embodiment, the projection portion of the mounting base is arranged along the entire outer edge of the diffuser. Therefore, the light leakage caused by the “sagging” of the diffuser can be more surely prevented. As a result, the deterioration of display qualities can be effectively prevented.

It is preferable that at least a surface facing the diffuser of the mounting base has reflectivity. The reflectivity used herein means that a reflectance for light (visible light) having a wavelength of about 380 nm to about 780 nm is about 80% or more, for example. The following methods are mentioned as a method of providing the mounting base with reflectivity. A method of using a reflective material for the mounting base, a method of subjecting a surface of the mounting base to a light-reflecting treatment, a method of attaching a reflective member to a surface of the mounting base, and the like, may be mentioned. As the method of subjecting the mounting base surface to a light-reflecting treatment, coating of a reflective coating material, formation of a metal thin film by deposition and the like, may be mentioned, for example. As the method of attaching a reflective member to the mounting base surface, attachment of a reflective tape, attachment of a reflective sheet with a cohesive member, and the like, may be mentioned. In such a preferred embodiment, the light leakage from the diffuser can be effectively prevented and light use efficiency can be improved.

It is preferable that the mounting base is made of polycarbonate or polypropylene. Polycarbonate and polypropylene can become white if they are each mixed with a reflective material. The reflectance can be arbitrarily changed in accordance with a concentration of the reflective material. Use of these materials makes it possible to easily provide the mounting base with light-shielding property and reflectivity. In addition, if polycarbonate or polypropylene is used for the mounting base, the mounting base can be easily processed, e.g., provided with the above-mentioned projection portion. Further, the use of such a plastic material leads to a reduction in weight of the mounting base.

It is preferable that the projection portion has a structure extending toward the diffuser, the structure being positioned above the diffuser. If such an extending structure is provided, a region covering the corner of the diffuser is expanded, and therefore, the effect of shielding light leaked from the corners of the diffuser can be much more obtained. In addition, the effect of preventing the warpage, attributed to that the corners of the diffuser are held down, can be simultaneously obtained. The projection portion is preferably arranged to be above the level of the upper surface of the diffuser, and therefore, just by forming a structure which extends from the top of the projection portion toward the diffuser, for example, the present preferred embodiment can be easily provided.

It is preferable that the diffuser is made of polycarbonate or a methyl methacrylate-styrene copolymer, for example. If polycarbonate (PC) or a methyl methacrylate-styrene copolymer (MS) is used for the diffuser, a diffuser excellent in light transmittance, durability, and lightweight property can be obtained.

It is preferable that the diffuser has a lens structure. Optical sheets such as a diffusion sheet, a lens sheet, and a polarization reflective sheet, for changing characteristics of light which has passed through the diffuser are generally arranged on the diffuser. The diffuser in the present preferred embodiment is prepared by providing a diffuser with lens functions which such an optical sheet and the like has. For example, a preferred embodiment in which a lenticular lens is stacked on a common diffuser and thereby they are integrated with each other is mentioned. In this preferred embodiment, a lens portion of the diffuser can be prevented from irregularly sagging by heat, and as a result, the diffuser functions and the lens functions can be consolidated and the effect of improving the luminance can be obtained.

Another preferred embodiment of the present invention provides a display device including the light source unit. The display device according to a preferred embodiment of the present invention includes the light source unit where the projection portion is located above the level of the upper surface of the diffuser and arranged along the outer edge of the diffuser. Therefore, the deterioration of display qualities, caused by the “sagging” of the diffuser, can be effectively prevented. As a result, the display device can exhibit excellent display qualities. A display device including a non-self-emission display panel is mentioned as the above-mentioned display device. For example, a liquid crystal display device including the liquid crystal panel is preferable. That is, the light source unit of a preferred embodiment of the present invention is preferably used as an illumination device for display devices, and particularly preferably used as a direct type backlight for liquid crystal display devices. It is preferable that the display device constitutes a television receiver. The display device of a preferred embodiment of the present invention includes the direct type light source unit where the diffuser is arranged above the light sources. Therefore, the display device is suitable for a television receiver which needs to be increased in size.

According to the light source unit of a preferred embodiment of the present invention, the projection portion is arranged to be above the level of the upper surface of the diffuser and arranged along the outer edge of the diffuser at the corners of the diffuser. Therefore, the deterioration of display qualities, caused by the “sagging” of the diffuser, can be effectively prevented.

Other features, elements, steps, characteristics and advantages of the present invention will become more apparent from the following detailed description of preferred embodiments of the present invention with reference to the attached drawings.

### BRIEF DESCRIPTION OF DRAWINGS

FIG. 1-1 is a perspective exploded view schematically showing the configuration of the direct type liquid crystal display device in accordance with Preferred Embodiment 1.

FIG. 1-2 is a cross-sectional view schematically showing the configuration of the direct type liquid crystal display device in accordance with Preferred Embodiment 1, as viewed in the direction perpendicular to the longitudinal direction of the linear light source.

FIGS. 2A, 2B and 2C are perspective views schematically showing the structure of the plastic frame included in the direct type liquid crystal display device in accordance with Preferred Embodiment 1, FIGS. 2A and 2B are enlarged views of a plastic frame, and FIG. 2C is an overall view showing the plastic frame and a diffuser.

FIGS. 3A and 3B are views schematically showing the method of holding the linear light sources in the direct type liquid crystal display device in accordance with Preferred Embodiment 1, wherein FIG. 3A is an enlarged perspective view of the light source-holding member, and FIG. 3B is a planar view showing arrangement of the light source-holding member.

FIG. 4 is a perspective view schematically showing an arrangement relationship between the plastic frame and the diffuser included in the direct type liquid crystal display device in accordance with Preferred Embodiment 2.

FIG. 5 is a perspective view schematically showing an arrangement relationship between the plastic frame and the diffuser included in the direct type liquid crystal display device in accordance with Preferred Embodiment 3.

FIGS. 6A and 6B are perspective views schematically showing the structure of the plastic frame included in the direct type liquid crystal display device in accordance with Preferred Embodiment 4, FIG. 6A is an enlarged view of the plastic frame, and FIG. 6B is an overall view showing the plastic frame and the diffuser.

FIG. 7 is a perspective view of the commonly used light source unit.

FIG. 8 is a schematic cross-sectional view of the light source unit taken along dashed line X-Y in FIG. 7.

### DETAILED DESCRIPTION OF THE PREFERRED EMBODIMENTS

The present invention is mentioned in more detail below with reference to preferred embodiments illustrated in the drawings, but is in no way limited to only these preferred embodiments.

### Preferred Embodiment 1

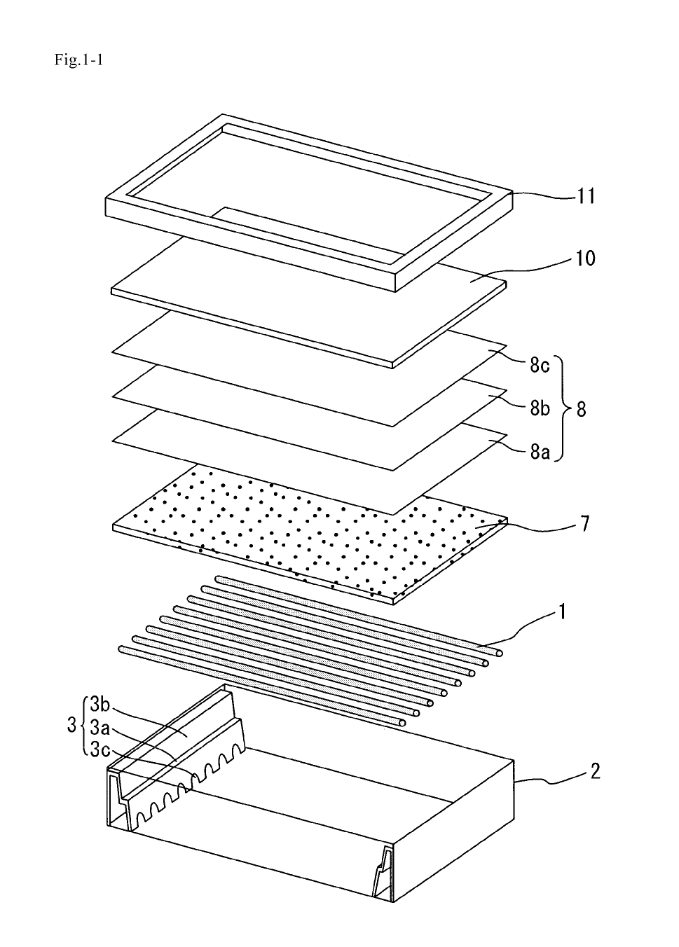

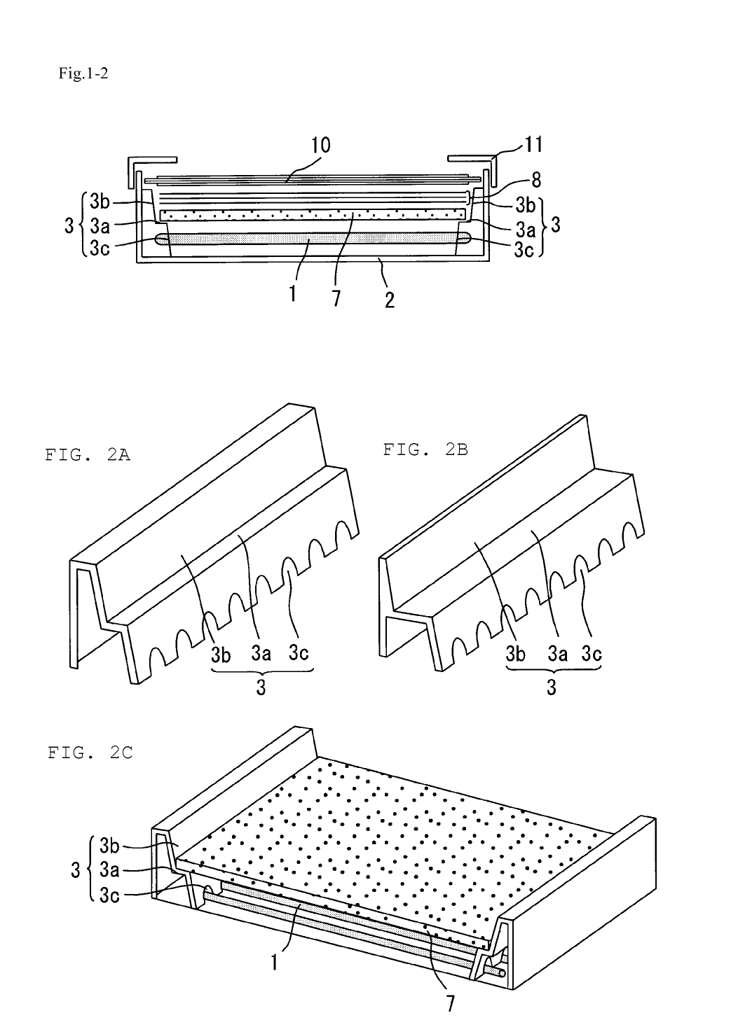

A light source unit in Preferred Embodiment 1 is in accordance with one preferred embodiment of the light source unit of the present invention, and it can be used as a direct type backlight for liquid crystal display devices. FIG. 1-1 is a perspective exploded view schematically showing a configuration of a liquid crystal display device in accordance with Preferred Embodiment 1. FIG. 1-2 is a cross-sectional view schematically showing the configuration of the liquid crystal display device in accordance with Preferred Embodiment 1, as viewed in the direction perpendicular to the longitudinal direction of a linear light source.

As shown in FIGS. 1-1 and 1-2, the liquid crystal display device in Preferred Embodiment 1 has a configuration in which a lower frame (light source chassis) 2, linear light sources 1, a plastic frame (mounting base) 3, a diffuser 7, optical sheets 8, a liquid crystal panel 10, and an upper frame (light source chassis) 11 are stacked.

### Lower Frame, Linear Light Source, and Mounting Base

The lower frame 2 is a box casing whose top is an opening. On the short sides of the inner periphery of the lower frame 2, the plastic frame 3 supporting the diffuser 7 is arranged. The plastic frame 3 is constituted by a diffuser-mounted portion 3a on which the diffuser 7 is placed, and a projection portion 3b arranged along the outer edge of the diffuser 7. According to Preferred Embodiment 1, this projection portion 3b is preferably arranged and disposed to be above the level of the upper surface of the diffuser 7 and has a function of shielding light leaked from the corners of the diffuser 7. Inside the lower frame 2, a plurality of the linear light sources (lamps) 1 are arranged in parallel or substantially parallel to each other, and both ends of the light sources 1 are within the plastic frame 3 through through-holes 3c the plastic frame 3 surface has. A reflective member is placed on the bottom of the lower frame 2 to reflect light from the linear light sources 1, and thereby use efficiency of light from the linear light sources 1 can be improved. Metals such as aluminum and stainless are preferably used as a material for the lower frame 2 in view of heat releasing property, mechanical strength, shape stability, lightweight property, and costs. A cold cathode fluorescent lamp is preferably used as the linear light sources 1.

The height of the projection portion 3b is appropriately determined in accordance with the warpage amount of the diffuser 7. The warpage amount of the diffuser 7 varies depending on the size or material (linear expansion coefficient) of the diffuser 7, use conditions, and the like. The following Table 1 shows measurement results of a warpage amount of the diffuser 7 which is made of polycarbonate and preferably has a thickness of about 2 mm or about 3 mm when the liquid crystal display device in Preferred Embodiment 1 is used under actual use conditions (for one hour after turning power on), and also shows a needed height of the projection portion 3b. The screen size in Table 1 is expressed as a length (inch) of a diagonal line of a display screen in the liquid crystal display device. The length is almost the same as a length of a diagonal line of the diffuser

TABLE 1

| | | Thickness of | | Height of |
|---|---|---|---|---|
| | | diffuser | Warpage amount | projection |
| Screen size | Material | [mm] | [cm] | [cm] |
| 65-inch | PC | 3 | 4 | 4.3 |
| 45-inch | PC | 2 | 3 | 3.2 |
| 37-inch | MS | 2 | 2 | 2.2 |
| 32-inch | MS | 2 | 2 | 2.2 |

As shown in Table 1, the warpage amount is 2 cm to 4 cm. As the screen size is increased, the diffuser 7 warps more and more.

FIGS. 2A, 2B and 2C are perspective views schematically showing a structure of a plastic frame in the backlight in accordance with Preferred Embodiment 1. FIG. 2A is an enlarged view of a plastic frame. FIG. 2C is an overall view showing the plastic frame and a diffuser. As shown in FIG. 2A, the plastic frame 3 has a two-stage structure constituted by the diffuser-mounted portion 3a and the projection portion 3b. The plastic frame 3 in Preferred Embodiment 1 has a hollow below the diffuser-mounted portion 3a so that the both ends of the light sources 1 are arranged below the diffuser-mounted portion 3a, as shown in the preferred embodiment in FIG. 2C. Further, the inner surface of the light source unit in the plastic frame 3 has a plurality of through-holes 3c so that the both ends of the light sources 1 are arranged within the hollow. The plastic frame 3 in Preferred Embodiment 1 is not limited to the preferred embodiment in which the inside of the projection portion 3b is also hollow as shown in FIG. 2A, as long as the plastic frame 3 has a hollow below the diffuser-mounted portion 3a. The plastic frame 3 may have a preferred embodiment in which the inside of the projection portion 3b is not hollow as shown in FIG. 2B. The diffuser-mounted portion 3a has a flat surface, and the projection portion 3b is inclined toward the inside of the light source unit so as to serve as the guide for regulating the position of the diffuser. The diffuser-mounted portion 3a surface is preferably provided with fine irregularities. In Preferred Embodiment 1, a light-shielding opalescent polycarbonate is used for the chassis (mounting-base), but the material is not especially limited. Plastics such as polypropylene also can be used, for example. Such a plastic frame 3 covers both ends of the light sources 1 which transversely penetrates the through-holes 3c, and further, the diffuser 7 is mounted on the diffuser-mounted portion 3a, as shown in FIG. 2C. Further, a reflective sheet is arranged on the diffuser-mounted portion 3a, and as a result, the light leakage from the diffuser 7 can be more effectively prevented and light use efficiency can be improved. According to Preferred Embodiment 1, the reflective sheet is a sheet member whose reflectance for light (visible light) having a wavelength of about 380 nm to about 780 nm is about 80% or more. The reflective sheet is preferably made of polyethylene terephthalate, and attached to the diffuser-mounted portion 3a with a cohesive member, for example. The projection portion 3b is arranged on the short sides of the diffuser 7, and as a result, the light leaked from the corners of the diffuser 7 can be sufficiently shielded, and the deterioration of display qualities can be prevented.

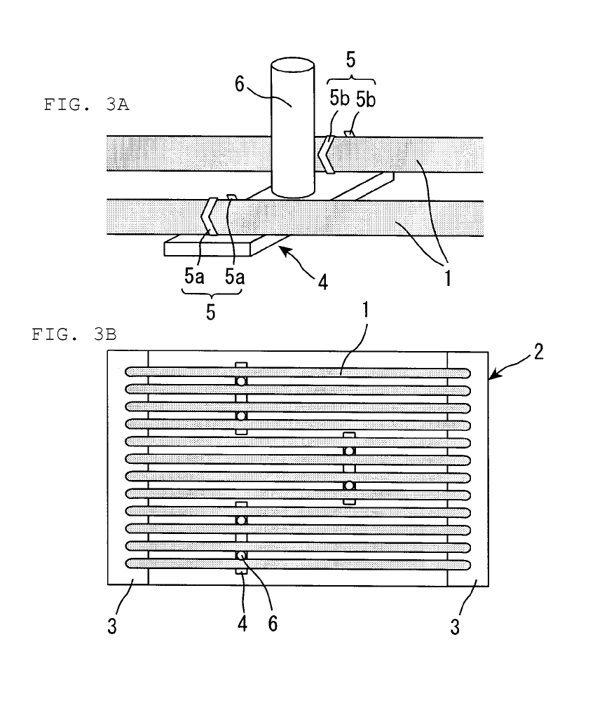

FIGS. 3A and 3B are views schematically showing a method of holding the linear light sources 1 in the liquid crystal display device in accordance with Preferred Embodiment 1. FIG. 3A is an enlarged perspective view of a light source-holding member 4. FIG. 3B is a planar view showing arrangement of the light source-holding member 4. As shown in FIG. 3, one light source-holding member 4 includes four light source-gripping portions 5 arranged at regular intervals and two supporting pins 6. A pair of the light source-gripping portions 5 forms a structure of gripping the linear light source 1 and fixes a position of the linear light source 1. The supporting pin 6 supports the diffuser 7 from below. The supporting pin 6 is arranged between the first light source-gripping portion 5a and the second light source-gripping portion 5b, and between the third light source-gripping portion and the fourth light source-gripping portion when the four light source-gripping portions 5 provided for one light source-holding member 4 are defined as the first light source-gripping portion 5a, the second light source-gripping portion 5b, the third light source-gripping portion, and the fourth light source-gripping portion.

### Diffuser and Optical Sheet

Above the lower frame 2, the diffuser 7 is arranged to cover the opening of the lower frame 2. Thus, by arranging the diffuser 7 above the light sources 1, an image of the light sources 1 can be eliminated. As a result, uniform in-plane light can be obtained. The diffuser 7 also serves as a base on which the below-mentioned optical sheets 8 are placed. The diffuser 7 is supported by the plastic frame 3 within the lower frame 2 and also by the supporting pin 6 provided for the light source-holding member 4.

The diffuser 7 preferably is a plate member having a substantially uniform thickness. The thickness of the diffuser 7 is preferably about 0.5 mm or more and about 4 mm or less, and more preferably about 2 mm or more and about 3 mm or less, for example. If the thickness of the diffuser 7 is too large, high costs, an increase in product weight, a reduction in luminance, and yellowing of emitted light, and the like, might be caused. If the thickness of the diffuser 7 is too small, uniformity of emission light becomes difficult to secure. Further, a variation in thickness directly leads to a variation in uniformity of emission light or in luminance. Therefore, product qualities become difficult to make uniform.

Examples of a material for the diffuser 7 include polycarbonate (PC), methyl methacrylate-styrene copolymer (MS), polymethylmethacrylate (PMMA), cycloolefins, and glass. Among these, polycarbonate, methyl methacrylate-styrene copolymer are preferably used. Each of the total light transmittance and a diffusion transmittance of the diffuser 7 is preferably about 20% to about 80% and more preferably about 40% to about 65%. If the total light transmittance and the diffusion transmittance of the diffuser 7 are too large, the uniformity of the emission light may be difficult to secure. If they are too small, the luminance of the emission light cannot be secured, which possibly results in a reduction in light emission efficiency.

The optical sheets 8 are arranged on the diffuser 7. The optical sheets 8 change characteristics of light which has passed through the diffuser 7. If necessary, one or more optical sheets such as a diffusion sheet, a lens sheet, and a polarization sheet, and the like, are appropriately used. According to Preferred Embodiment 1, three optical sheets 8 such as a lower diffusion sheet 8a, a prism sheet (lens sheet) 8b, and an upper diffusion sheet 8c are arranged in this order from the light sources 1 side. A preferred embodiment in which a polarization reflective sheet is arranged instead of the upper diffusion sheet 8c is also preferably employed. Polyethylene terephthalate (PET), polycarbonate, and the like, are mentioned as a material for the diffusion sheet 8a. Examples of a material for the prism sheet 8b include UV curable resins such as an acrylic resin and materials prepared by mixing polyethylene terephthalate with UV curable resins such as an acrylic resin. As the diffuser 7 in Preferred Embodiment 1, a diffuser which is integrated with a lens structure may be used. In such a case, the number of the optical sheets 8 arranged on the diffuser may be decreased.

### Liquid Crystal Panel and Upper Frame

The liquid crystal panel 10 is arranged above the optical sheets 8. The liquid crystal panel 10 has a configuration in which a liquid crystal layer is interposed between glass substrates, and a retardation film, a polarizer, and the like, are each attached to glass substrate surfaces on the side opposite to the liquid crystal layer side. In addition, the upper frame 11 is fitted with the lower frame 2 from the display surface side of the liquid crystal panel 10. Examples of a preferable material for the upper frame 11 include a metal such as aluminum and stainless, similarly to the lower frame 2.

In such a manner, the liquid crystal display device in Preferred Embodiment 1 is completed.

The liquid crystal display device in Preferred Embodiment 1 can provide display with display qualities whose deterioration is sufficiently prevented because the light leakage generated at the corners of the diffuser is minimized and prevented.

### Preferred Embodiment 2

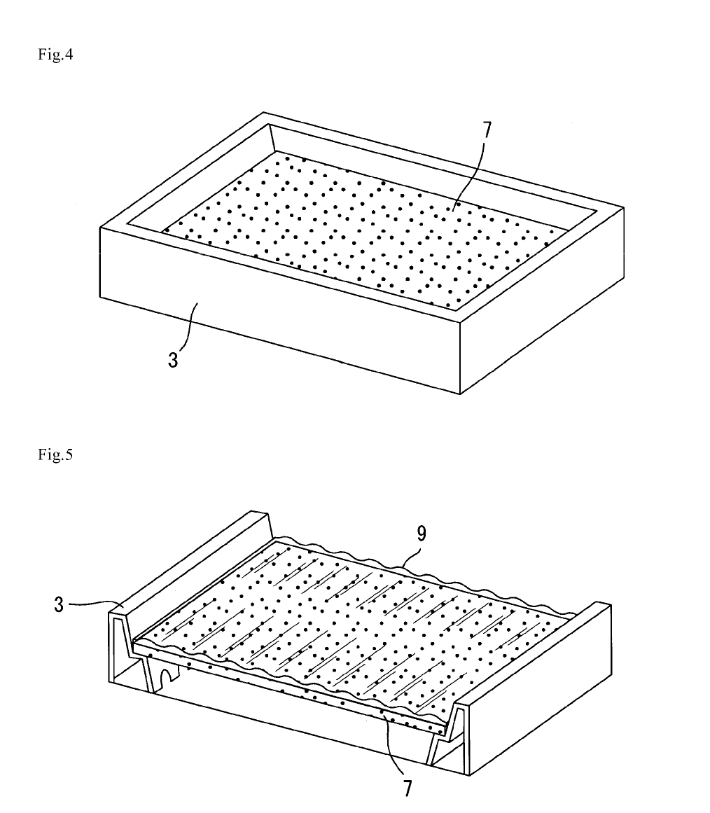

A light source unit in Preferred Embodiment 2 is in accordance with another preferred embodiment of the light source unit of the present invention, and it can be used as a direct type backlight for liquid crystal display devices. FIG. 4 is a perspective view schematically showing an arrangement relationship between the plastic frame (mounting base) and the diffuser in the backlight in accordance with Preferred Embodiment 2. The backlight in Preferred Embodiment 2 is the same as in Preferred Embodiment 1, except that the plastic frame 3 is circularly arranged below the outer edge of the diffuser 7. That is, according to the present preferred embodiment, the plastic frame 3 is arranged below the outer edge of the diffuser 7. The projection portion of the plastic frame 3 surrounds the diffuser 7.

According to such an arrangement of the plastic frame 3, light leakage, generated by the “sagging” of the diffuser 7, can be more surely shielded not only at the corners but also in the entire outer edge of the diffuser 7. As a result, the deterioration of display qualities can be effectively prevented.

### Preferred Embodiment 3

A light source unit in Preferred Embodiment 3 is in accordance with another preferred embodiment of the light source unit of the present invention, and it can be used as a direct type backlight for liquid crystal display devices. The configuration of the backlight in Preferred Embodiment 3 is the same as in Preferred Embodiment 1, except that a lenticular lens is arranged on a surface of the diffuser. FIG. 5 is a perspective view schematically showing an arrangement relationship between a plastic frame (mounting base) and a diffuser in the backlight in accordance with Preferred Embodiment 3. As shown in FIG. 5, a lenticular lens 9 is arranged on a surface of the diffuser 7 mounted on the plastic frame 3, and thereby the diffuser 7 is integrated with the lenticular lens 9. Therefore, there is no need to arrange a lens sheet, and it does not occur that a lens sheet unevenly sags. As a result, the diffuser functions and the lens functions can be consolidated and the effect of improving the luminance can be obtained.

### Preferred Embodiment 4

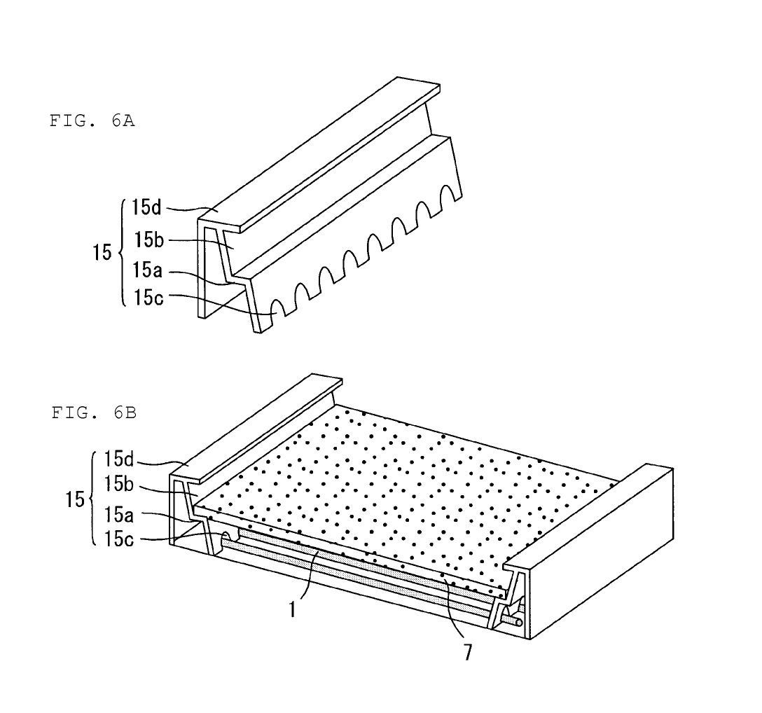

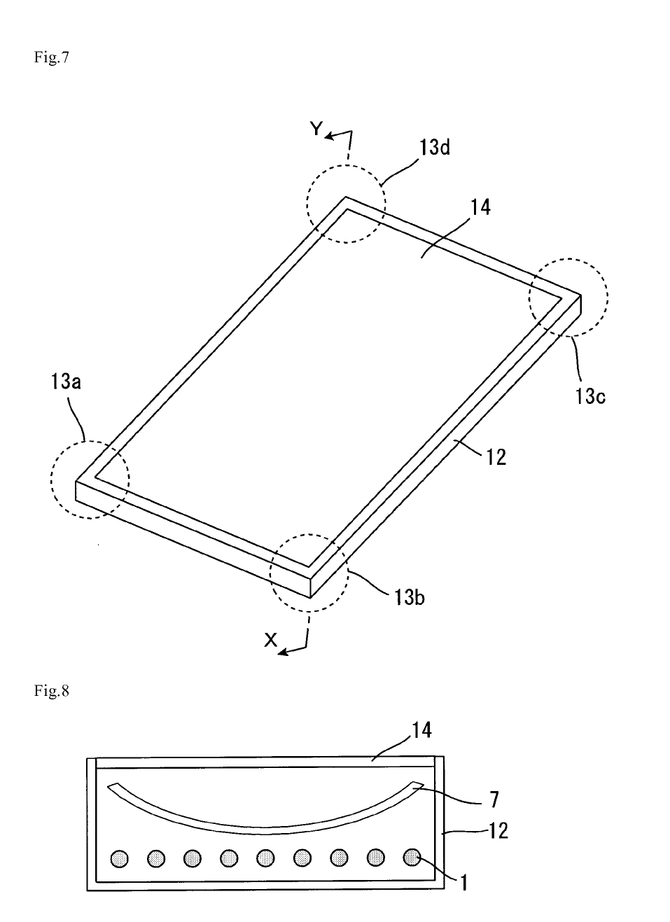

A light source unit in Preferred Embodiment 4 is in accordance with another preferred embodiment of the light source unit of the present invention, and it can be used as a direct type backlight for liquid crystal display devices. The configuration of the backlight in Preferred Embodiment 4 is the same as in Preferred Embodiment 1, except that as the mounting base, a plastic frame which includes a projection portion whose top is provided with an extending portion, which extends toward the diffuser. FIGS. 6A and 6B are perspective views schematically showing the structure of the plastic frame in the backlight in accordance with Preferred Embodiment 4. FIG. 6A is an enlarged view of a plastic frame. FIG. 6B is an overall view showing the plastic frame and a diffuser.

As shown in FIG. 6A, a plastic frame 15 preferably has a two-stage structure including a diffuser-mounted portion 15a and a projection portion 15b. Further, the top of the projection portion 15b is provided with an extending portion 15d. Further, the inner surface of the light source unit in the plastic frame 15 has a plurality of through-holes 15c which light sources transversely penetrates. As shown in FIG. 6B, the light sources 1 transversely penetrate the through holes 15c so that both ends of the light sources 1 are arranged below the diffuser-mounted portion 15a, and the diffuser 7 is placed on the diffuser-mounted portion 15a, as shown in FIG. 6B. It is optimal that the extending portion 15d which the top of the projection portion 15b has the structure extending toward the diffuser 7 as far as possible unless it overlaps with an active display region. The following Table 2 shows a suitable length of the extending portion 15b. If such an extending portion 15d is arranged, a region covering the corner of the diffuser 7 is expanded, and therefore, the effect of shielding light leaked from the corners of the diffuser can be much more obtained. In addition, the effect of preventing the warpage, attributed to that the corners of the diffuser are held down, can be simultaneously obtained.

TABLE 2

| | Length of |
|---|---|
| | extending part |
| Screen size | [mm] |
| 65-inch | 10 |
| 45-inch | 10 |
| 37-inch | 8 |
| 32-inch | 6 |

### Preferred Embodiment 5

The liquid crystal display devices in Preferred Embodiments 1 to 4 can provide display with display qualities whose deterioration is effectively prevented. Therefore, if these liquid crystal display devices each constitute a television receiver, for example, a television which displays images with high quality can be provided.

The present application claims priority under the Paris Convention and the domestic law in the country to be entered into national phase on Patent Application No. 2006-327266 filed in Japan on Dec. 4, 2006, the entire contents of which are hereby incorporated by reference.

The terms “or more” and “or less” in the present description mean that the value described (boundary value) is included.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-9. (canceled)

10. A light source unit comprising:
a light source;
a diffuser; and
a light source chassis; wherein
the diffuser has a main surface facing the light source and is arranged within the light source chassis;
the light source unit includes a mounting base at least below a corner of the diffuser;
the mounting base includes a diffuser-mounted portion and a projection portion, the projection portion being arranged along an outer edge of the diffuser;
the projection portion has a light-shielding property; and
the projection portion is arranged to be above a level of an upper surface of the diffuser.

11. The light source unit according to claim 10, wherein the mounting base is circularly arranged below the outer edge of the diffuser.

12. The light source unit according to claim 10, wherein at least a surface facing the diffuser of the mounting base has reflectivity.

13. The light source unit according to claim 10, wherein the mounting base is made of polycarbonate or polypropylene.

14. The light source unit according to claim 10, wherein the projection portion has a structure extending toward the diffuser, the structure being positioned above the diffuser.

15. The light source unit according to claim 10, wherein the diffuser is made of polycarbonate or a methyl methacrylate-styrene copolymer.

16. The light source unit according to claim 10, wherein the diffuser has a lens structure.

17. A display device comprising the light source unit according to claim 10. cm 18. A television receiver comprising the display device according to claim 17.
